(19) United States
(12) Patent Application Publication
(10) Pub. No.: US 2007/0211398 A1
(43) Pub. Date: Sep. 13, 2007

(54) SUPPRESSING ELECTROSTATIC DISCHARGE ASSOCIATED WITH RADIO FREQUENCY IDENTIFICATION TAGS

(75) Inventor: Stephen J. Whitney, Lake Zurich, IL (US)

Correspondence Address: BELL, BOYD & LLOYD LLP, P.O. BOX 1135, CHICAGO, IL, 60690, US

(73) Assignee: Littelfuse, Inc., Des Plaines, IL (US)

(21) Appl. No.: 11/684,474

(22) Filed: Mar. 9, 2007

Related U.S. Application Data
(60) Provisional application No. 60/780,986, filed on Mar. 10, 2006.

(51) Int. Cl. H02H 3/00; H02H 9/08; G08B 13/14

(52) U.S. Cl. 361/42; 340/572.8

(57) ABSTRACT

An electrostatic discharge control system and circuit uses a voltage variable material to protect an electrical circuit, such as radio frequency identification (RFID) tag, from electrostatic damage, The circuit includes two separate electrical circuit traces with a gap between the traces. The circuit includes and protects an electrical device, such as an integrated circuit, connected between the traces. The circuit includes a voltage variable material disposed adjacent to the gap and configured to directly electrically couple the first circuit trace to the second circuit trace upon occurrence of an electrostatic discharge event. The voltage variable material may be anisotropic.

### PRIORITY CLAIM

This application claims the benefit of U.S. Provisional Application No. 60/780,986, filed Mar. 10, 2006, entitled “Systems and Methods for Suppressing Electrostatic Discharge Associated with Radio Frequency Identification Tags,” the entire contents of which are hereby incorporated by reference and relied upon.

### BACKGROUND

The use of radio frequency identification (“RFID”) tags is well known. RFID tags are often used to replace traditional barcodes and supplement known identification labels. RFID tags relate to any chip or device that can be sensed or read at a distance and through objects or obstructions via radio frequencies. Often RFID tags are attached to palletized goods to allow a user to inventory all of the goods simultaneously by simply interrogating their respective tags with a reader. By way of contrast, if traditional bar-codes are utilized, each item on a pallet, and the pallet itself, has to be individually scanned to verify the contents and status. Thus, RFID tags offer significant time saving and efficiency advantages.

RFID tags can also be used in consumer applications to ensure and track product quality, status and location. As the technology matures, RFID tags may be used to provide interactive or multimedia product instructions, prescription advice and other useful information.

RFID tags typically include an integrated circuit constructed from a semiconductor material and insulating materials. Semiconductor materials, for example, silicon, and insulating materials, for example, silicon dioxide are susceptible to damage caused by electrostatic discharge (“ESD”) or the sudden and momentary electric current caused by an excess electric charge built up on a portion of the tag, which flows to another object with a different electrical potential. ESD can break down semiconductor and insulating materials comprising the integrated circuit which, in turn, cause the RFID to fail.

As the use of RFID tags becomes commonplace and their functionality and complexity increases, failure and inoperability of the tags will have increasingly negative consequences. It is therefore advantageous to provide a system, apparatus and/or method that protects RFID tags and other similar devices or circuits from unwanted and potentially harmful ESD events.

### SUMMARY

A system and method of suppressing and controlling electrostatic discharge and protecting against damage caused by electrostatic discharge events is disclosed herein. In particular, an electrostatic discharge control system includes voltage variable materials to compensate for and equalize the electrostatic charge that may accumulate between portions of a non-continuous electrical circuit is disclosed.

In one embodiment, an electrostatic discharge suppression system includes an electrical circuit having a first circuit trace and a second circuit trace aligned with the first circuit trace and configured to define a gap therebetween. The system further includes an electrical device with a first contact configured to connect to the first circuit trace and a second contact configured to connect to the second circuit trace. The embodiment also includes a voltage variable material disposed adjacent to the gap in an anisotropic configuration to directly electrically couple the first circuit trace to the second circuit trace upon occurrence of an electrostatic discharge event.

In another embodiment, an electrostatic discharge suppression system includes an antenna having a first circuit trace and a second circuit trace aligned with the first circuit trace and configured to define a gap therebetween. The system further includes an RFID device with a first contact configured for electrical connection with the first circuit trace and a second contact configured for electrical connection with the second circuit trace. The embodiment also includes a voltage variable material disposed adjacent to the gap in an anisotropic manner and configured to directly electrically couple the first circuit trace to the second circuit trace upon occurrence of an electrostatic discharge event.

In a further embodiment, a method of suppressing electrostatic discharge includes providing an antenna, defining a gap between first and second portions of the antenna, electrically coupling an RFID device to the first and second portions of the antenna, and depositing a voltage variable material in the gap, wherein the voltage variable material is deposited in an anisotropic manner to electrically couple the first and second portions of the antenna upon occurrence of an electrostatic discharge event.

Systems and methods constructed in accordance with the disclosure provided herein can advantageously suppress and control electrostatic discharge and protect electronic devices such as, for example, RFID tags from damage caused by an electrostatic discharge event. Moreover, these exemplary systems and methods are cost efficient and easy to manufacture. Furthermore, these exemplary systems and methods offer greater structural strength and resistance to stresses caused by thermal conductivity mismatches between the materials, components, etc. Additional features and advantages of the present invention are described in, and will be apparent from, the following Detailed Description and the figures.

### BRIEF DESCRIPTION OF THE FIGURES

FIG. 1 illustrates a known radio frequency identification system.

FIG. 2 illustrates one embodiment of a radio frequency identification device constructed according to the teachings of the present disclosure.

FIG. 3 illustrates an exploded view of the radio frequency identification device shown in FIG. 2.

FIG. 4 illustrates a sectional view of another embodiment of the radio frequency identification device taken along the section line III-III shown in FIG. 3.

FIG. 5 illustrates a sectional view of another embodiment of the radio frequency identification device taken along the section line III-III shown in FIG. 3.

FIGS. 6A and 6B illustrate enlarged sectional views of the attachment of the radio frequency identification device as shown in call-out V of FIG. 5.

FIG. 7 illustrates a sectional view of another embodiment of the radio frequency identification device taken along the section line III-III shown in FIG. 3.

FIGS. 8A and 8B illustrate another embodiment of a radio frequency identification device constructed according to the teachings of the present disclosure.

FIG. 9 illustrates an embodiment of a chip assembly for use with a radio frequency identification device constructed according to the teachings of the present disclosure.

FIG. 10 illustrates the anisotropy that may exist in a voltage variable material in embodiments of an electrostatic discharge control system.

FIG. 11 illustrates another electrostatic discharge suppression system using anisotropy to protect an electronic device.

### DETAILED DESCRIPTION

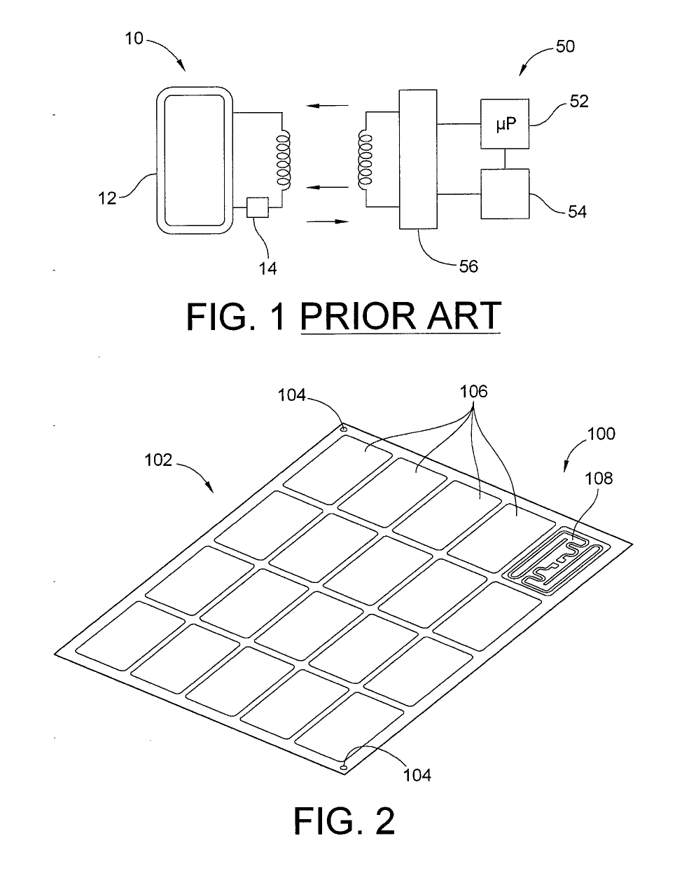

FIG. 1 illustrates a known radio frequency identification system that includes a reader 50 configured to cooperate with a radio frequency identification (“RFID”) tag 10. The reader 50, which may be a hand-held device, such as a personal digital assistant or scanner, includes a processor 52 coupled to a power source 54 and a transceiver 56. The RFID tag 10 includes an antenna 12 that may, or may not, be coupled to an integrated circuit chip or chip 14 that can store or contain additional product information, tracking information, shipping information or any other desired product information. In operation, the processor 52, powered by the power source 54, provides a signal that is transmitted by the transceiver 56. The transmission energy of the signal communicated by the transceiver 56 serves to inductively and communicatively couple the RFID tag 10 to the reader 50. An electrical current is, in turn, inductively generated within the antenna 12. The electrical current can serve as a “zero bit” to simply indicate the presence or absence of the RFID tag 10. Alternatively, the electrical current can power the chip 14, thereby allowing the additional information stored thereon to be communicated between the RFID tag 10 and the reader 50.

The RFID tag 10 as illustrated is a passive tag, which includes no internal power source and instead is inductively powered and interrogated by the reader 50. In application with the present disclosure, RFID tag 10 can alternatively be a semi-passive device that includes a battery that is printed onto the substrate. The addition of the printed battery power source allows the antenna 12 to be optimized for communication, as opposed to current generation. In another embodiment, the RFID tag 10 can be an active tag that includes a long-life battery, one or more integrated circuits 14, display elements, storage elements, etc.

For purposes of the present disclosure, and regardless of its physical configuration, RFID tag 10 includes any device configured to communicate information via radio waves transmitted at frequencies of about 100 kHz or higher. In fact, the operating frequencies of individual tags can be considered a secondary consideration given that the overall structures of typical tags are very similar. Thus, the frequencies at which a particular tag operates is not of primary concern, rather the susceptibility of the typical tag or tag structure/configuration to damage caused by an ESD event is of interest.

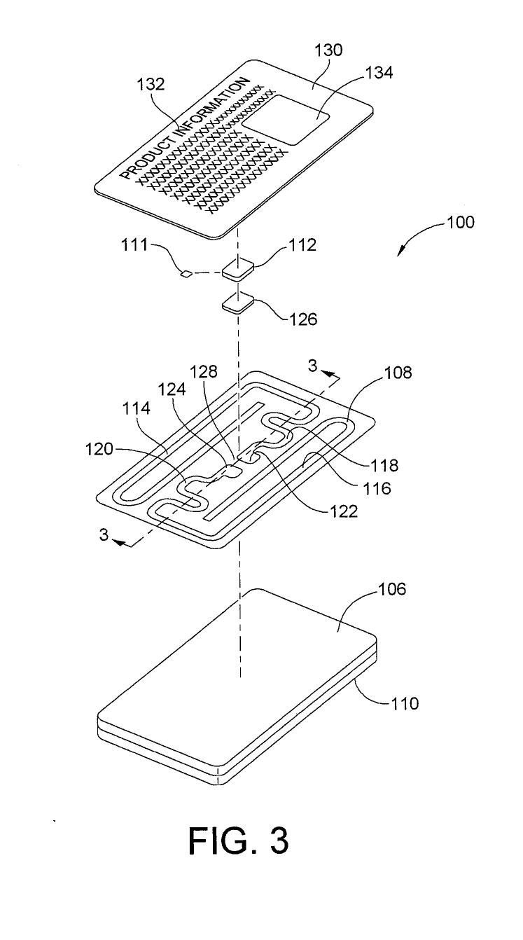

FIGS. 2 and 3 illustrate one embodiment of a radio frequency identification (RFID) tag 100 constructed according to the teachings of the present disclosure. FIG. 2 shows a multipanel substrate 102 configured for use in a printing process. The multipanel substrate 102 includes tooling holes or fiducials 104 for physical and/or visual alignment with a screen printer or printer (not shown). The multipanel substrate 102 further includes a plurality of individual panels 106 supported within a common matrix. In this arrangement, each individual panel 106 on the multipanel substrate 102 can be simultaneously printed using metallized ink or paste to define, for example, an antenna 108, a battery (not shown), an organic light emitting diode (“OLED”) matrix (not shown), a processor, etc. This arrangement allows for high speed manufacturing of the multiple RFID tags, which is beneficial as the demand for these devices increases.

FIG. 3 illustrates an exploded view of the layers of the RFID tag 100 that can be manufactured as an element of the multipanel substrate 102. For example, in this exemplary embodiment, the panel 106 is separated from the multipanel substrate 102 and supports a pressure adhesive layer 110 on the lower surface. The panel 106 can be, for example, a pre-scored panel that allows for easy mechanical separation from the multipanel substrate 102. Alternatively, the panel 106 can be punched or cut away from the multipanel substrate 102 in any known manner. Regardless of how the individual panels 106 are removed from the matrix formed by the multipanel substrate 102, the adhesive layer 110 provides a mechanism by which a mechanical bond may be formed between the RFID tag 100 and another object. It will be understood that the panel 106 could be an active substrate, a rigid substrate such as FR-4, ceramic, glass, a flexible substrate or any variation therebetween based on the application in which the RFID tag 100 is to be utilized.

The antenna 108 may be deposited on the upper surface of the panel 106 via, for example, an ink jet process. The antenna 108 includes a first antenna portion 114 and a second antenna portion 116. The first antenna portion 114 includes a first circuit trace 118 and a first pad 122. The second antenna portion 116 includes a second circuit trace 120 and a second pad 124. The first and second pads 122, 124 can be configured to support or connect to a silicon chip 112, which may, or may not, be an integrated circuit such as the chip 14. The silicon chip 112 can be configured or programmed to perform a variety of tasks such as, for example, storing product information, product status, product location, directions for product use, etc. As previously discussed in connection with the integrated circuit chip 14, the chip 112 can be powered via energy received from the reader 50 in the form of an inductive current generated through the antenna 108. Alternatively, chip 112 may be powered by a battery 111 that is part of the circuit. Battery 111 may be a discrete battery placed onto the substrate or may be a low-cost battery that is printed onto the substrate as part of the RFID circuit. Additionally, the circuit may include a source of illumination 113, such as an OLED, connected at least to the integrated circuit 112.

In the illustrated embodiment, a voltage variable material 126 is deposited across a gap 128 defined between the first and second pads 122, 124. The voltage variable material may include an insulative binder that, in turn, supports and secures one or more or all of certain different types of particles, such as insulating particles, semiconductive particles, doped semiconductive particles, conductive particles and various combinations of these. The insulative binder may have intrinsically adhesive properties and self-adhere to surfaces, such as a conductive, metal surface or a non-conductive, insulative surface. The insulative binder may further be a self-curing binder, such that voltage variable material 126 may be applied to the gap 128 and first and second pads 122, 124 and be used thereafter without heating or otherwise curing. It should be appreciated, however, that voltage variable material 126, including the binder, may be heated or cured to accelerate the curing process. Other embodiments of the voltage variable material are disclosed in commonly-assigned U.S. Pat. No. 7,183,891, titled “Direct Application Voltage Variable Material, Devices Employing Same and Methods of Manufacturing such Devices”, the entire contents of which are incorporated herein by reference for all purposes. The voltage variable material may be screen printed onto the pads and into the gap, stencil printed, dispensed in a controlled and direct manner from a pressurized source of the material, or may be pick and place dispensed.

Conductive particles are effectively used in embodiments of the electrostatic discharge suppression system. Conductive particles may include particles of aluminum, brass, carbon black, copper, graphite, gold, iron, nickel, palladium, platinum, silver, stainless steel, tin, titanium, tungsten, zinc and alloys thereof, as well as other metal alloys. In one embodiment, the particles preferably have a particle size less than 60 microns (micrometers). Other embodiments have particle sizes less than 20 microns, or less than 10 microns. In yet another embodiment, conductive particles with average particle size less than 1 micron, down to the nanometer range, are used.

Semiconductive or insulating particles may also be used to suppress and control electrostatic discharge. In one embodiment, semiconductive particles include particles of fumed silica (“Cab-O-Sil”), silicon carbide, oxides of bismuth, copper, zinc, calcium, vanadium, iron, magnesium, calcium and titanium; carbides of silicon, aluminum, chromium, titanium, molybdenum, beryllium, boron, tungsten and vanadium; sulfides of cadmium, zinc, lead, molybdenum, and silver; nitrides such as boron nitride, silicon nitride and aluminum nitride; barium titanate and iron titanate; silicides of molybdenum and chromium; and borides of chromium, molybdenum, niobium and tungsten. In another embodiment, the semiconductive particles include particle of one or more of silicon carbide, barium titanate, boron nitride, boron phosphide, cadmium phosphide, cadmium sulfide, gallium nitride, gallium phosphide, germanium, indium phosphide, magnesium oxide, silicon, zinc oxide, and zinc sulfide, as well as electrically somewhat conducting polymers, such as polypyrole or polyaniline. These materials are doped with suitable electron donors for example, phosphorous, arsenic, or antimony or electron acceptors, such as iron, aluminum, boron, or gallium, to achieve a desired level of electrical conductivity. Insulating particles may be somewhat smaller than those of conductive particles, with preferred sizes in the range of 200 to about 1000 Angstroms (Å), and a bulk conductivity of less than 1 Siemens/m. Semi-conductive particles may have somewhat larger particle sizes, such as from about 0.1 microns to about 5 microns.

In some embodiments, insulating particles may also include particles of the following materials: glass, glass spheres, calcium carbonate, calcium sulfate, barium sulfate, aluminum trihydrate, kaolin, kaolinite, plastics, such as very small particles of thermoplastic or thermoset polymers. The insulating particles may also include oxides of iron, aluminum, zinc, titanium, copper and clay, such as a montmorillonite or bentonite type clay.

In other embodiments, a very thin layer of glass or polymer that acts as an insulator under normal conditions of operation may be used as a voltage variable material. These materials include thin mats or layers of glass or polymer fibers, such as aramid fibers, also known as Nomex® or Kevlar® fiber. Polymers may also include silicone rubber and elastomer, natural rubber, organopolysiloxane, polyethylene, polypropylene, polystyrene, poly(methyl methacrylate), polyacrylonitrile, polyacetal, polycarbonate, polyamide, polyester, phenol-formaldehyde, epoxy, alkyd, polyurethane, polyimide, phenoxy, polysulfide, polyphenylene oxide, polyvinyl chloride, fluoropolymer and chlorofluoropolymer. These materials, especially mats of very thin, i.e., low denier fibers, may be used with a liquid or paste adhesive-matrix to adhere to layers between which a voltage variable material is desired. When an electrostatic discharge event occurs, conduction can then occur across or through the material, protecting the circuit of which it is a part. For example, such a layer or mat may be used in one direction for a higher voltage discharge, while alternate materials may be used in another direction for a lower voltage discharge, or even for conduction under normal operation, as discussed below. These materials thus provide a way to achieve anisotropic protection against electrostatic discharge, also further discussed below.

The voltage variable material 126 protects against electrical overstress transients that produce high electric fields and unusually high peak power. As previously discussed, these electrical overstress transients or discharges can render the chip 112 or other highly sensitive electrical components in the circuits, temporarily or permanently non-functional. An electrical transient may occur when an excess charge develops or accumulates on, for example, the first antenna portion 114 and discharges to the second antenna portion 116, through the chip 112. The electrical discharge or transient can rise to its maximum amplitude in subnanosecond to microsecond times and have repeating amplitude peaks.

The voltage variable material 126 placed over the gap 128 exhibits a high electrical impedance state at low or normal operating voltages. When an electrical discharge or build-up occurs, the voltage variable material switches very rapidly to a low impedance state. Thus, in the example defined above, the charge accumulated on the first antenna portion 114 discharges to the second antenna portion 116 through the voltage variable material 126, instead of the through the chip 112. When the electrical transient dissipates, the voltage variable material 126 returns to its high resistance state. In this way, the voltage variable material 126 protects the chip 112 during these transient events by equalizing the electrical potential or charge between the first and second antenna portions 114, 116. Subsequently, the charge or electrical potential stored on the first and second antenna portions 114, 116 of the antenna 108 can be capacitively coupled and discharged to ground.

Alternatively, the panel 106 or the entire multipanel substrate 102 may be manufactured from the voltage variable material 126, thereby eliminating the need to deposit additional material on the gap 128 and first and second pads 122, 124. In this arrangement, the first and second antenna portions 114, 116 and the first and second pads 122, 124 are deposited on the voltage variable material 126, and are electrically coupled only when an electrostatic discharge event occurs.

As seen in FIG. 3, the RFID tag 100 can further include a label layer 130. The label layer 130 may be a static label that includes product information 132, a logo 134 and any other desired information. Alternatively, the label layer 130 could be an active label such as an OLED label that displays changing information. The active label may be controlled by the chip 112 or may include its own processor or controller. In another embodiment, the voltage variable material 126 may be printed as a continuous layer above, or below, the antenna 108.

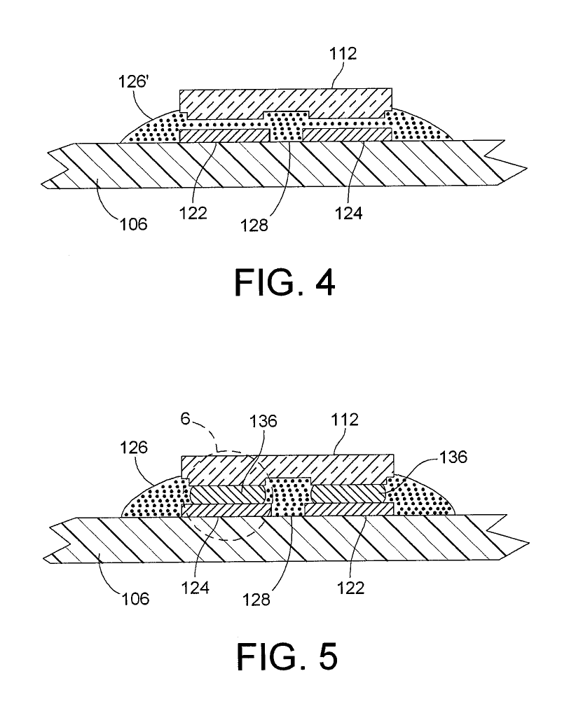

FIG. 4 illustrates a sectional view taken along the section line III-III of FIG. 3, which shows the chip 112 arranged adjacent to the first and second pads 122, 124. In this exemplary embodiment, the chip 112 is secured above (in the indicated z-direction) the gap 128 and pads 122, 124 via voltage variable material 126. The voltage variable material 126 as configured in this embodiment provides a number of advantages. For example, the voltage variable material 126 includes an insulative binder, which may or may not be a self-curing binder, which bonds the chip 112 to the pads 122, 124 and adjacent to the gap 128. In this example, the voltage variable material 126 indicated by the reference numeral 126′ takes on anisotropic properties when compressed between the chip 112 and the pads 122, 124, allowing for electrical conduction in only the z-direction during normal operations. This is because the thickness of the material is much less in the z-direction, between the chip and the pads, than in a direction perpendicular to the z-direction, such as the horizontal direction between pads 122 and 124. In other words, once the RFID tag 100 is assembled, the voltage variable material 126′ promotes electrical communication only between the chip 112 and the pads 122, 124, and inhibits or deters electrical communication between the pads 122, 124. Thus, upon occurrence of an electrostatic discharge event, the voltage variable material 126′ suppresses and protects electrical communication between the chip 112 and the first and second antenna portions 114, 116. In this example, it is the configuration or design of the circuit that adds the anisotropic aspect to the circuit. In other examples, the materials themselves may have properties that are different in different directions, i.e., they are inherently anisotropic. Systems for electrostatic discharge suppression or control may use either method, or both methods, to achieve the circuit protection.

FIG. 5 illustrates another sectional view taken along the section line III-III of FIG. 3 of the chip 112 arranged adjacent to the first and second pads 122, 124. In this embodiment, the chip 112 may be secured to the first and second pads 122, 124 utilizing a conductive element generally indicated by the reference numeral 136. The conductive element 136 provides electrical communication between the first and second pads 122, 124 and the corresponding contacts on the chip 112. Voltage variable material 126 is used as an underfill material to support and secure the chip 112 after attachment. The use of the voltage variable material 126 as underfill serves to compensate for differences in the coefficient of thermal expansion between the panel 110 and the chip 112. If not, these differences can cause the panel 110 and the chip 112 to expand and/or contract at difference rates which, in turn, imposes a cyclical stress on the conductive elements 136. Over time, the stress on the conductive elements may cause cracking or separation of the chip from the first and second pads 122, 124 thereby reducing or destroying the functionality of the RFID chip 100. Thus, in this exemplary embodiment, the voltage variable material 126 is configured to electrically and mechanically protect the chip 112 from physical, e.g., cyclical, stresses and electrostatic discharge events.

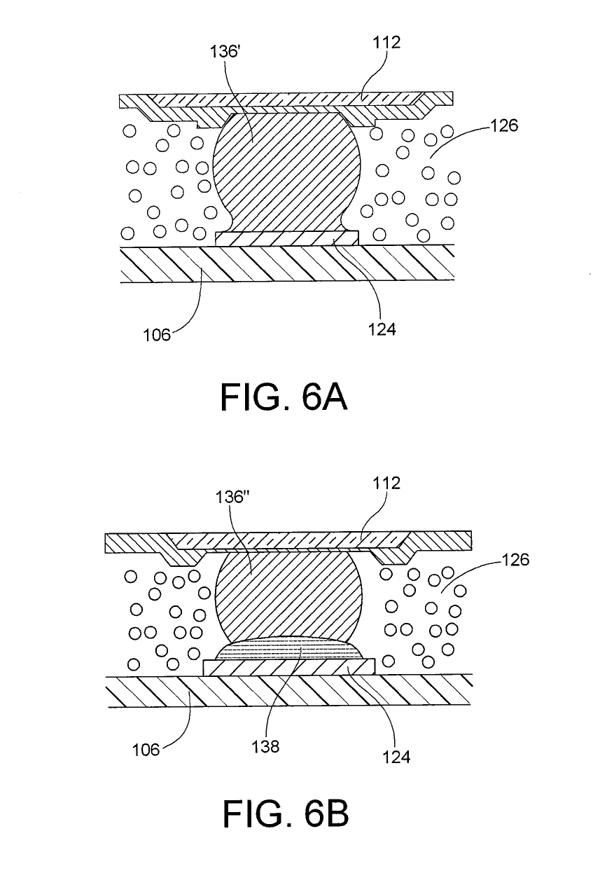

FIG. 6A illustrates an enlarged sectional view generally indicated by the call-out V shown in FIG. 5. In one embodiment, the conductive element 136 is a solder ball generally indicated by the reference numeral 136′, which is metallurgically bonded to the second pad 124. The metallurgical bond is established for example by heating the solder ball 136′ and the second pad 124 to a point at which the two materials alloy.

FIG. 6B illustrates another enlarged sectional view generally indicated by the call-out V shown in FIG. 5. In this embodiment, the conductive element 136 is a gold bump generally indicated by the reference numeral 136″. The gold bump 136″ is mechanically bonded or joined onto the chip 112 and bonded to the second pad 124, for example, via an isotropic conductive adhesive 138. The conductive adhesive 138 may be deposited on the surface of the second pad 124 to establish a physical connection between the gold bump 136″ and the second pad 124 formed on the panel 110. Regardless of the conductive element 136, 136′ and 136″ employed in FIGS. 6A and 6B, the voltage variable material 126 underfills and supports chip 112, and suppresses electrostatic discharge events between the first and second antenna portions 114, 116, which terminate at first and second pads 122, 124 and gap 128.

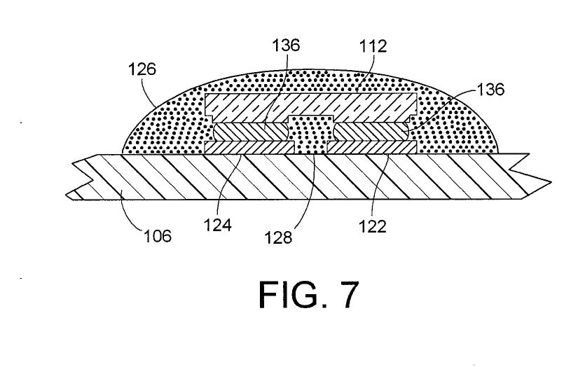

FIG. 7 illustrates a further sectional view taken along the section line III-III of the chip 112 in FIG. 3, which again resides in the z-direction above first and second pads 122, 124. In this embodiment, the chip 112 may be secured to the first and second pads 122, 124 in any known manner, e.g., via conductive elements 136, and encapsulated with voltage variable material 126. Encapsulation protects the chip 112, pads 122, 124, and portions of the circuit traces 118, 120 (not illustrated) from accidental damage and exposure to contaminants. As shown, the encapsulating the voltage variable material 126 completely covers and underfills the chip 112 and the pads 122, 124. In this configuration, the voltage variable material 126: (i) protects against electrical discharges across the gap 128; (ii) protects against thermal stresses as discussed in connection with FIGS. 6A and 6B; and (iii) enhances the physical robustness of the entire RFID tag 100.

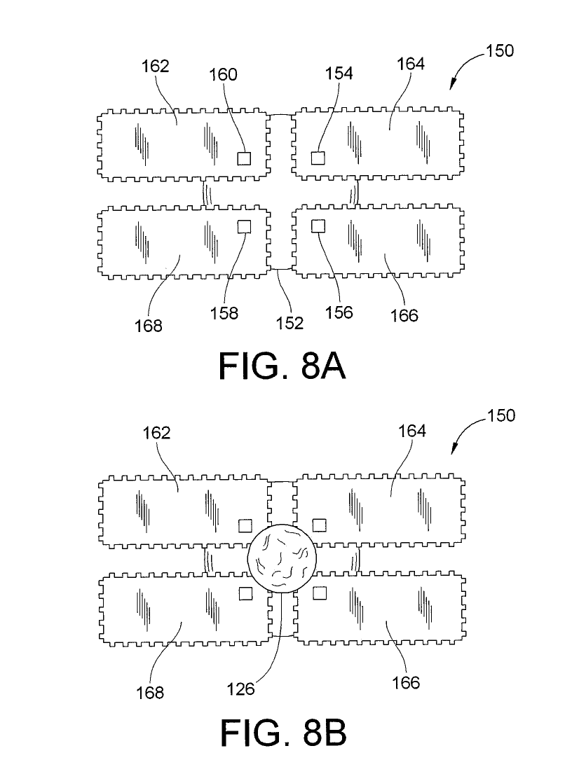

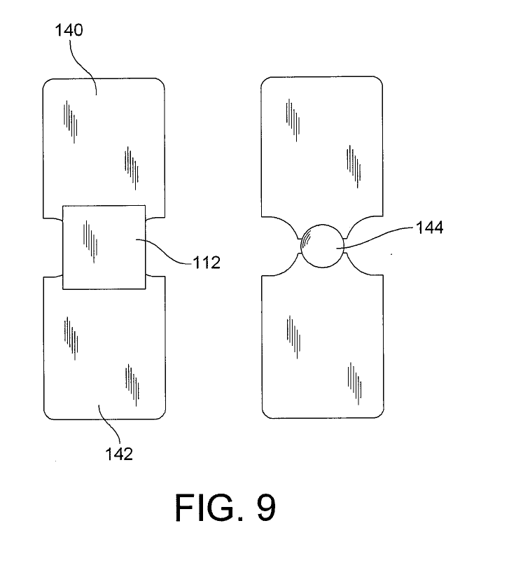

FIGS. 8A and 8B illustrate another embodiment of an RFID tag 150 that also includes electrostatic discharge protection. The RFID tag 150 is a flip chip with printed antenna portions. The tag includes a chip or die 152 having contact bumps 154, 156, 158 and 160 arrayed about the perimeter of the die. The contact bumps 154, 156, 158 and 160 may be formed in any known bumping process from a variety of electrically conductive materials, for example, conductive adhesive, gold, and solders such as tin-lead, tin-silver-copper, tin-bismuth, or tin-silver solder. The illustrated RFID tag 150 further includes printed antenna portions 162, 164, 166 and 168. The printed antenna portions 162, 164, 166 and 168 contact and overlay the contact bumps 154, 156, 158 and 160 of the die 152. This arrangement allows for an electrical connection to be established between the die 152 and the antenna.

FIG. 8B illustrates the RFID tag 150 cooperating with a voltage variable material 126. The voltage variable material 126 can be deposited on the die 152. The voltage variable material 126 also contacts printed antenna portions 162, 164, 166, 168. In this configuration, an electrostatic buildup on any one of the antenna portions 162, 164, 166, 168 can be distributed and equalized between the other antenna portions 162, 164, 166, 168 before the die 152 is harmed by the discharge. As discussed above, the equalized charge on each of the antenna portions 162, 164, 166, 168 can be capacitively coupled and discharged to ground.

FIG. 9 illustrates another embodiment of a radio frequency identification device, in which the chip 112 is attached, in an off-line array process, to structures that can be efficiently integrated into high-speed graphic arts printing processes. For example, the chip 112 is affixed to first and second leads 140, 142 using a conductive adhesive dot 144 disposed between the first and second leads 140, 142. The first and second leads 140, 142 can be manufactured on a strap or tape 146 and wound reel-to-reel to allow the conductive adhesive 144 and the silicon ship 112 to be applied. It will be understood that the conductive adhesive 144 could be a voltage variable material such as, for example, a self-curing material. Thus, the chip 112 could be encapsulated, supported or otherwise attached to the leads 140, 142 via the voltage variable material. The resulting chip and lead assembly may be removed from the tape 146 and conductively secured to, for example, the pads 122, 124 using, for example, voltage variable material 126.

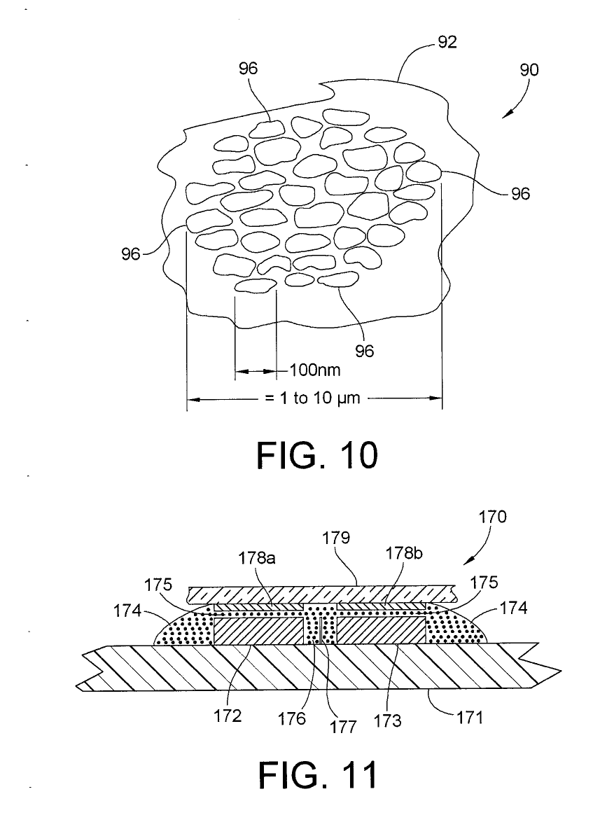

It will be recognized that the components of a voltage variable material may include a matrix, or majority of the material, such as an adhesive or other organic-type material, and a filler, such as a conductive metal. FIG. 10 depicts such a material 90, in which an adhesive matrix 92 surrounds conductive tungsten particles 96, with an average size of about 100 nm (nanometers) Some of the particles have an aspect ratio, i.e., are longer in one dimension than in the other two dimensions. The aspect ratio of the particulates may result in anisotropic electrical properties, i.e., the material will conduct better in one direction than in another.

In the present example, the material will conduct electricity better in the direction of the longer axis of the conductive particles, i.e., from side to side in FIG. 10, rather than from top to bottom. The anisotropy will be enhanced if the material flows during its application or printing, and the particles align in the preferred direction. In this instance, the preferred direction for conductivity is the Z-direction, that is, conductivity is desired between the antenna or pads of the RFID device and the silicon chip or integrated circuit portion. Such Z-direction conductivity can be facilitated by using a thin layer of voltage variable material between the antenna or pads and the chip. Alternatively, different materials may be used, with a less-conductive voltage variable material in the gap in which electrostatic discharge will be encouraged, and a more-conductive material atop the less conductive material and between the antenna or pads and the chip. For example, the fibers and polymers discussed above may be sandwiched into the gap to provide a protection against electrostatic discharge, while thin layers of an adhesive-paste voltage variable material may be used to secure the mat or polymer in place and also to provide some conduction between the antenna and the RFID chip, or other conductors in other applications.

An example of such a protective system is illustrated in FIG. 11. Electrostatic discharge system 170 includes a circuit substrate 171, such as a polymeric or composite substrate. Substrate 171 includes conductors 172, 173, which may be portions of an RFID antenna, or which may be other parts of an electronic circuit. A first voltage variable material 177 may be placed in the gap 176 between the conductors. Material 177 is a glass or polymer mat as described above, and is sandwiched between layers of a second voltage variable material 174. Second material 174 may be an adhesive, liquid or paste-type material with particulate fillers. Material 174 fills in the remainder of gap 176 and may also overlay the tops of conductor 172, 173 in a very thin layer 175, sufficiently thin that electrical conduction may occur under normal operation between conductors 172, 173, and electronic device 179. In some embodiments, additional conductive elements 178a, 178b may be placed between the thin layers 175 and electronic device 179. Under normal conditions, electric power or signals conduct between conductor 172, first element 178a and device 179, and also separately, between device 179, second element 178b, and second conductor 173. When an electrostatic discharge event occurs, first voltage variable material 177 and second voltage material 174 conduct across gap 176 to discharge the electrostatic charge in an anisotropic manner.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. An electrostatic discharge suppression system, comprising:
an electrical circuit with a first circuit trace and a second circuit trace aligned with the first circuit trace and configured to define a gap therebetween;
an electrical device with a first contact configured to connect to the first circuit trace and a second contact configured to connect to the second circuit trace; and
a voltage variable material disposed adjacent to the gap in an anisotropic configuration to directly electrically couple the first circuit trace to the second circuit trace upon occurrence of an electrostatic discharge event.

2. The system of claim 1, wherein the electrical circuit is an antenna for an RFID tag.

3. The system of claim 1, wherein the electrical device is an integrated circuit.

4. The system of claim 1, wherein the voltage variable material is anisotropic.

5. The system of claim 1, wherein the voltage variable material is a conductive adhesive.

6. The system of claim 1, further comprising a flexible substrate or a rigid substrate.

7. The system of claim 1, wherein the voltage variable material underfills at least a portion of the electrical device.

8. An electrostatic discharge suppression system, comprising:
an antenna having a first circuit trace and a second circuit trace aligned with the first circuit trace and configured to define a gap therebetween;
an RFID device with a first contact configured for electrical connection with the first circuit trace and a second contact configured for electrical connection with the second circuit trace; and
a voltage variable material disposed adjacent to the gap in an anisotropic manner and configured to directly electrically couple the first circuit trace to the second circuit trace upon occurrence of an electrostatic discharge event.

9. The system of claim 8, wherein the voltage variable material underfills the RFID device.

10. The system of claim 8, further comprising a battery placed into the circuit or printed for connection to the circuit.

11. The system of claim 8, further comprising a substrate supporting at least the antenna and the RFID device, and a battery connected to at least the RFID device.

12. The system of claim 8, wherein the voltage variable material is configured to allow electrical conductivity between the RFID device and the antenna in normal operation and is configured to directly electrically couple the first circuit trace to the second circuit trace upon occurrence of an electrostatic discharge event.

13. The system of claim 8, further comprising a conductive device between at least one of the first and second circuit traces and the first and second contacts.

14. A method of suppressing electrostatic discharge, the method comprising:
providing an antenna;
defining a gap between first and second portions of the antenna;
electrically coupling an RFID device to the first and second portions of the antenna; and
depositing a voltage variable material in the gap, wherein the voltage variable material is deposited in an anisotropic manner to electrically couple the first and second portions of the antenna upon occurrence of an electrostatic discharge event.

15. The method of claim 14, wherein providing the antenna comprises printing an electrically conductive material to define the antenna.

16. The method of claim 14, further comprising providing a power source or a light source coupled to the RFID device.

17. The method of claim 14, further comprising depositing a conductive device atop the antenna before electrically coupling the RFID device to the antenna.

18. The method of claim 14, wherein the step of providing the voltage variable material includes providing at least a thin layer of the voltage variable material between the RFID device and the antenna such that there is electrical conductivity between the RFID device and the antenna in normal operation.

19. The method of claim 14, wherein the voltage variable material itself is an anisotropic material.

20. The method of claim 14, wherein the step of depositing is selected from the group of pick and place dispensed, directly dispensed, printed, screen printed, or stencil printed.
